(19) United States
(12) Patent Application Publication
(10) Pub. No.: US 2015/0276670 A1
(43) Pub. Date: Oct. 1, 2015

(54) ELECTROCHEMICAL BIOSENSING METER, SYSTEM AND MEASURING METHOD FOR ANALYTE MEASUREMENT INCORPORATING FILLED SAMPLE DETECTION

(71) Applicant: TAIDOC TECHNOLOGY CORPORATION, New Taipei City (TW)

(72) Inventors: CHIA-CHI WU, NEW TAIPEI CITY (TW); HUI-SHENG HOU, NEW TAIPEI CITY (TW); TAI-CHENG CHOU, NEW TAIPEI CITY (TW); CHAO-WANG CHEN, NEW TAIPEI CITY (TW)

(21) Appl. No.: 14/672,219

(22) Filed: Mar. 29, 2015

(30) Foreign Application Priority Data
Mar. 31, 2014 (TW) 103112082

(51) Int. Cl. G01N 27/416; G01N 27/327

(52) U.S. Cl. CPC G01N 27/4163; G01N 27/3274; G01N 27/3272; G01N 27/3273

(57) ABSTRACT

The present invention related to an electrochemical biosensing meter, a system and a measuring method for analyte measurement incorporating filled sample detection. The method comprises detecting a third electrical signal obtained from a second electrode pair on a test strip and detecting a second electrical signal obtained from a first electrode pair on the test strip. The second electrode pair is close to a sample entrance of a sample chamber and the first electrode pair is far away from the sample entrance of the sample chamber. The third electrical signal is used for detecting the state of the sample chamber when sufficiently filled. Compare the second electrical signal and the third electrical signal to determine the distribution state of the sample in the sample chamber. Therefore, it increases the credibility for the entire sample chamber sufficiently filled with the sample.

### BACKGROUND OF THE INVENTION

1. Field of the Invention

The present invention relates in general to a method and a system for analyte measurement incorporating filled sample detection, and particularly relates to a method and a system for determining analyte concentration in liquid sample and repetitively detecting the electrical signal obtained from an electrode which close to the sample entrance to determine the distribution state or the flow velocity of the sample in sample chamber.

2. Description of the Related Art

Since the progression of technology and the change of life style, many tests operated in hospital from the past may be operated at home now. The lifestyle change is more relevant to increase the patient number of chronic disease so as to accelerate the industry development for home diagnosis, and the test items such as blood glucose, ovulation and pregnancy diagnosis is preferred to perform at home.

In market, many types of disposable biosensor strip are designed for non-professional users and operated at home without contamination issue. The strip is coordinated with the mating biosensing meter so as to obtain the measuring physiology value.

Conventional electrochemical biosensor strip comprises a base, a conducting layer, a reagent layer, an isolating layer and a cover. The conducting layer is laid on the base and includes an anode part and a cathode part which the disposed pattern is separately non-contacted with each other. The isolating layer is partially laid down onto the conducting layer so as to expose portion of the conducting layer. The exposed portion of the anode and the cathode are respectively formed a working electrode and a counter/reference electrode at one end, and the other end of the conducting layer are connected with the mating biosensing meter. The working electrode and the counter/reference electrode have been covered with the reagent layer which applied for different application as needed and the cover is laid on the reagent layer.

The base, the space upon the partial exposed conducting layer and the cover is cooperated to form a sample chamber. When the sample dropped or absorbed into the sample chamber, the reagent layer is reacted with the sample to perform varied electrochemical reaction and then transmitted the reacting signal to the anode portion and the cathode portion by the working electrode and the counter/reference electrode. The electrochemical biosensing meter is connected with the strip and received the signal so as to calculate and display the analyte concentration in the sample.

However, in the electrochemical field, the method for analyte measurement needs a sufficient amount of sample to react on a defined surface area of the exposed electrode and with a preset reagent which is reacting with the analyte. Users need to supply a sufficient amount of sample for filling the sample chamber. The filled sample fully distributed on the electrode surface area within the sample chamber and the quantitative sample volume completely reacted with the reagent layer is needed to comply with the preset controlling factor in the electrochemical biosensing meter. When the sample volume is insufficient, the sample could not completely perform the reaction with the reagent layer which contains the preset enzyme and mediator so that influence the electron transmission generated from electrochemical reaction for electrical signal detected. Therefore, whether the filled sample volume has been sufficient will affect the accuracy of the test result for analyte concentration measurement.

Conventional electrochemical method for analyte measurement may not detect the filled sample volume or set an extra fill-detected electrode for sample filling detection which usually disposed at downstream of the sample flowing path in the sample chamber and far away from the sample entrance. According to the assumption design for the fill-detected electrode position in the condition of insufficient sample volume, the sample will be received at the sample entrance then flowing from the upstream toward the downstream and dose not contact the fill-detected electrode which is disposed at downstream of the sample chamber so that the electrical signal for the sample chamber filled with the sample will not be detected. On the contrary, when the sample volume is sufficient, the sample received from the sample entrance to the fill-detected electrode and fully filled the sample chamber so that the electrical signal of the sample chamber has been filled with the sample will be detected.

However, there are many different types of the sample distribution pattern in the actual insufficient sample volume condition and do not accord with the flowing path from the upstream to the downstream in the sample chamber. Therefore, the conventional fill-detected electrode disposed at downstream of the flowing path on the electrochemical biosensor strip cannot accurately detect the sample filled condition. If the sample chamber filled with insufficient sample, executed the measurement procedure will make severely misjudged the test result for the analyte accuracy.

Furthermore, after the sample introduced into the sample chamber, the electrochemical biosensing meter is applying an electrical signal to let the analyte of the sample reacted with the reagent layer so as to cause electron transmission at the electrodes, and then detected an electrical signal at a preset time period so as to calculate the analyte concentration. Therefore, the flow velocity of sample distributed in the sample chamber at a preset time period is one affected factor for analyte measurement of the test result.

There are many factors to influence the flow velocity of the sample distribution in the sample chamber, such as hematocrit over limited regular value in the sample, the abnormality of test strip itself or filled sample volume insufficient and so on. If the filled sample volume apparently insufficient, user may operate to resupply the sample into the sample chamber so that exceed the reaction time or detected time preset in the electrochemical biosensing meter so as to misjudge the analyte concentration of test result. Hence, there is an issue for manufacturer that how to establish a system and a method for enhancing accuracy of filled sample detection and excluding human operation error so as to need further improvement about deficiency described above for manufacturer.

### SUMMARY OF THE INVENTION

According to one aspect of the present invention is to provide an electrochemical biosensing system for filling sample detection that no need to dispose an extra fill-detected electrode on the test strip used for detecting sample volume insufficient, and the arrangement of electrode pair disposed on the test strip let the electrochemical biosensing meter can apply lower voltage for analyte detection so as to evaluate the sensitivity of analyte concentration measurement.

The present invention provides a system and a method for filling sample detection that resolve the misjudged problem of sample distribution about sample distributed along the edge of sample chamber due to insufficient filled sample volume so that detecting the electrical signal close to the sample entrance or repetitively detected the electrical signal close to the sample entrance so as to determine the flow velocity and the distribution state of the sample in the sample chamber.

In one aspect of the present invention, the present invention provides a method for filling sample detection, comprising:

providing an electrochemical biosensor strip used for determining an analyte concentration in a sample, which comprising
a sample chamber containing a first end and a second end, and the first end and the second end disposed in relative position, and the first end having a sample entrance; and
a conducting layer comprising a first electrode pair and a second electrode pair and one end of the first electrode pair and the second electrode pair respectively disposed in the sample chamber, wherein the end of the first electrode pair is far away from the first end of the sample chamber and the end of the second electrode pair is close to the first end of the sample chamber;

providing the sample at the sample entrance to let the sample fill into the sample chamber;

detecting a second electrical signal obtained from the first electrode pair;

detecting a third electrical signal obtained from the second electrode pair, and the third electrical signal used for determining the filled state of the sample chamber;

comparing the second electrical signal and the third electrical signal; and

determining the distribution state of the sample in the sample chamber.

In an embodiment in accordance with the present invention, the method before the step of detecting the second electrical signal further comprises:

detecting a first electrical signal obtained from the second electrode pair, and the first electrical signal used for determining the filled state of the sample chamber when start; and

comparing the first electrical signal, the second electrical signal and the third electrical signal to determine the distribution state of the sample in the sample chamber.

In an embodiment in accordance with the present invention, the step of comparing the electrical signals to determine the distribution state of the sample in the sample chamber which is obtained a difference value from comparing the electrical signals and the difference value less than a predetermined value to indicate the sample chamber insufficiently filled with the sample.

In an embodiment in accordance with the present invention, the step of comparing the electrical signals to determine the distribution state of the sample in the sample chamber which is the electrical signals all satisfied with a predetermined value to indicate the sample chamber insufficiently filled with the sample.

In an embodiment in accordance with the present invention, determining the distribution state of the sample in the sample chamber which is determining the flow velocity of the sample distributed in the sample chamber according to a comparing result from the comparing step.

In an embodiment in accordance with the present invention, the electrical signals are voltage value, current value, resistance value, impedance value, capacitance value or any combination from the one of description above.

In another aspect in accordance with the present invention, the present invention provides a electrochemical biosensing meter for filling sample detection, which used for inserting an electrochemical biosensor strip to determine an analyte concentration in a sample, and the electrochemical biosensor strip comprising a sample chamber including a sample entrance, and a conducting layer including a first electrode pair and a second electrode pair and one end of the first electrode pair and the second electrode pair respectively disposed in the sample chamber, wherein the end of the first electrode pair is far away from the sample entrance and the end of the second electrode pair is close to the sample entrance, and the meter comprising:

a connector used for inserting the electrochemical biosensor strip;

a detecting element used for detecting electrical signals respectively obtained from the first electrode pair and the second electrode pair when the sample contacted, the electrical signals including a first electrical signal and a third electrical signal obtained from the second electrode pair and a second electrical signal obtained from the first electrode pair, a detecting time of the third electrical signal being later than the detecting time the first electrical signal and the second electrical signal, and the first electrical signal used for determining the filled state of the sample chamber when start and the third electrical signal used for determining the filled state of the sample chamber when sufficiently filled; and

a processing element used for calculating the first electrical signal, the second electrical signal and the third electrical signal to determine the distribution state of the sample in the sample chamber.

In an embodiment in accordance with the present invention, the processing element is used for calculating a difference value which obtained from the disparity between the first electrical signal, the second electrical signal and the third electrical signal and the difference value less than a predetermined value to indicate the sample sufficiently filled with the sample chamber.

In an embodiment in accordance with the present invention, the processing element is used for calculating the first electrical signal, the second electrical signal and the third electrical signal to compare with a predetermined value and all electrical signals satisfy with the predetermined value to indicate the sample sufficiently filled with the sample chamber.

In an embodiment in accordance with the present invention, the processing element is used for determining a flow velocity of the sample distributed in the sample chamber based on the distribution state of the sample.

In an embodiment in accordance with the present invention, the first electrical signal, the second electrical signal or the third electrical signal is voltage value, current value, resistance value, impedance value, capacitance value or any combination from the one of description above.

In an embodiment in accordance with the present invention, the electrochemical biosensing meter further comprises a display element connected with the processing element and used for receiving the signal from the processing element to display a processing procedure. In an embodiment in accordance with the present invention, the processing procedure displayed on the display element comprises a step of the sample chamber sufficiently filled with the sample so as to continue the procedure for determining the analyte concentration in the sample, or a step of the sample chamber insufficiently filled with the sample so as to stop the procedure for determining the analyte concentration in the sample.

In an embodiment in accordance with the present invention, the electrochemical biosensing meter further comprises a memory element used for storing the analyte concentration detected from the sample, correction parameters for different batch of the biosensor strip, the predetermined value for comparing with the difference value obtained from the electrical signals or the predetermined value for each electrical signals satisfied with.

In one another aspect of the present invention, the present invention provides a system for filling sample detection, which is used for determining an analyte concentration in a sample, comprising:

an electrochemical biosensor strip comprising
a base;
a conducting layer disposed on the base and comprising a first electrode pair and a second electrode pair;
a reagent layer contacted with the conducting layer used for reacting with the analyte in the sample; and
a cover cooperating with the base to form a sample chamber; and

an electrochemical biosensing meter description above, used for optionally inserting the electrochemical biosensor strip.

In an embodiment in accordance with the present invention, one end respectively of the first electrode pair and the second electrode pair on the electrochemical biosensor strip are used for contacted with the sample and the other end respectively of the first electrode pair and the second electrode pair are used for close to or contacted with the electrochemical biosensing meter.

In an embodiment in accordance with the present invention, the system of the electrochemical biosensor strip of the first electrode pair and the second electrode pair respectively comprises a working electrode and a counter/reference electrode and the electrical signals are voltage value, current value, resistance value, impedance value, capacitance value or any combination from the one of description above. Preferably, the working electrode and the counter/reference electrode are disposed in the same plane or parallel with opposite plan.

In an embodiment in accordance with the present invention, the working electrode of the first electrode pair is closed to the second end of the sample chamber, the working electrode of the second electrode pair is closed to the first end of the sample chamber and the counter/reference electrodes of the first electrode pair and the second electrode pair are disposed in the middle of each working electrodes.

According to the aspect of the present invention as description above, repetitively detected the electrical signal generated from the electrode which disposed close to the sample entrance so as to confirm whether the sample sufficiently filled at the sample entrance from the upstream to the downstream of the sample chamber. The present invention provides no need to dispose an extra fill-detected electrode on the test strip so as to reduce the manufacturing cost, and resolve the misjudged problem of sample distribution caused by sample distributed along the edge of sample chamber. Also, the present invention provides determining the flow velocity and the distribution state of the sample in the sample chamber so as to decrease human operation error and evaluated the accuracy and efficiency for analyte measurement.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic perspective view of a preferred embodiment of an electrochemical biosensor strip in accordance with the present invention;

FIG. 2 is an exploded schematic perspective view of the preferred embodiment of the electrochemical biosensor strip in FIG. 1 in accordance with the present invention;

FIG. 3A is a schematic perspective view of a conducting layer and an isolating layer in FIG. 1 in accordance with the present invention;

FIG. 3B is a schematic perspective view of a carbon layer in FIG. 3A;

FIG. 3C is a partial enlarged schematic perspective view at one end of the strip in FIG. 3A;

FIG. 4A is a schematic perspective view of a second preferred embodiment of a conducting layer and an isolating layer in accordance with the present invention;

FIG. 4B is a schematic perspective view of a carbon layer in FIG. 4A;

FIG. 4C is a partial enlarged schematic perspective view at one end of the strip in FIG. 4A;

FIG. 5 is a schematic perspective view of a third preferred embodiment of the electrochemical biosensor strip in accordance with the present invention;

FIG. 6 is a block diagram of a preferred embodiment of a system for filling sample detection in accordance with the present invention;

FIGS. 7A to 7O are perspective views of different distribution state of the sample in the sample chamber in FIG. 4C;

FIGS. 8A to 8L are schematic perspective views of different preferred embodiment of a first electrode pair and a second electrode pair disposed in the sample chamber in accordance with the present invention, wherein FIGS. 8C, 8D, 8G and 8H are respectively a lateral side view of FIGS. 8A, 8B, 8E and 8F. In these Figures, the sample chamber and the electrodes exposed from the sample entrance are drawn by solid line and other electrodes of the electrode pair in the sample chamber are drawn by dotted line;

FIG. 9 is a flow chart of a preferred embodiment of a method for filling sample detection in accordance with the present invention; and

FIG. 10 is a flow chart of another preferred embodiment of a method for filling sample detection in accordance with the present invention.

### DESCRIPTION OF THE PREFERRED EMBODIMENTS

For the purposes of promoting an understanding of the principles of the invention, reference will now be made to the embodiment illustrated in the drawings, and specific language will be used to describe that embodiment. It will nevertheless be understood that no limitation of the scope of the invention is intended. Alterations and modifications in the illustrated device, and further applications of the principles of the invention as illustrated therein, as would normally occur to one skilled in the art to which the invention relates are contemplated, are desired to be protected. Such alternative embodiments require certain adaptations to the embodiments discussed herein that would be obvious to those skilled in the art.

The following description and accompanying drawings are some examples in accordance with the present invention. The same symbol herein in the drawings indicates the same or similar structure.

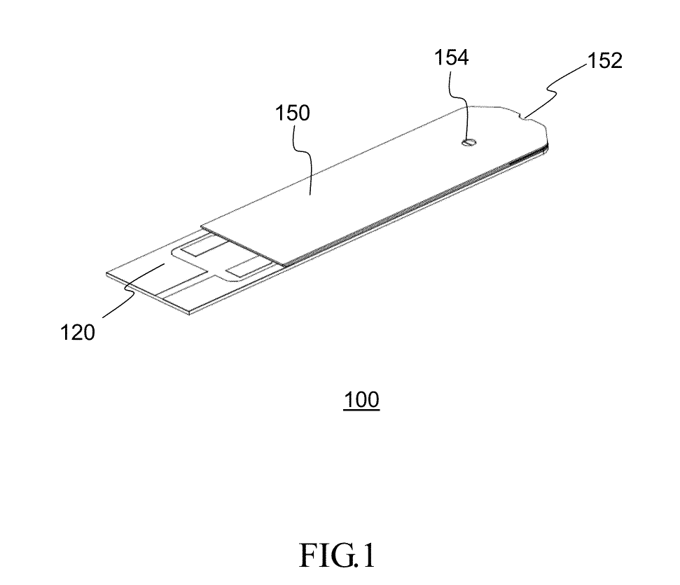

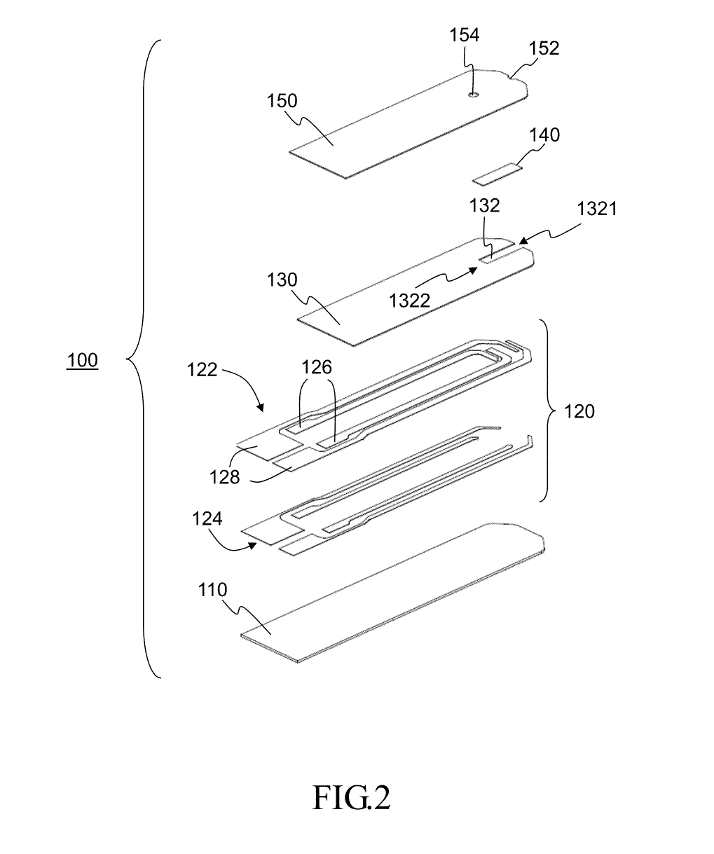

FIG. 1 is a schematic perspective view of a preferred embodiment of an electrochemical biosensor strip in accordance with the present invention. FIG. 2 is an exploded schematic perspective view of the preferred embodiment of the electrochemical biosensor strip in FIG. 1 in accordance with the present invention. Please refer to FIGS. 1 and 2 in combination. A test strip (100) of an embodiment in accordance with the present invention is provided and used for determining an analyte concentration in a sample. Preferably, the test strip (100) can be the electrochemical test strip and the sample can be liquid. More preferably, the test strip (100) can be the electrochemical biosensor strip and the sample can be liquid obtained from human body such as blood, urine, plasma, serum, cerebro-spinal fluid (CFS), spinal fluid or other body fluid. The sample can contain one or more than one kinds of analyte, and the kinds of analyte can include but not limit with blood glucose, blood cell, glycosylated hemoglobin, urinary protein or other test targets for liver function.

The test strip (100) comprises a base (110), a conducting layer (120), a reagent layer (140) and a cover (150). Preferably, the test strip (100) further comprises an isolating layer (130). The base can be an insulating substance and has electrical insulating characteristic. Preferably, the appearance of the base (110) can be square-typed. More preferably, one or more angles of the square-typed base (110) can be obtuse or curved mode to prevent users from harming by sharp angle, but the present invention shall not be limited in this. Those skilled in the art can change or modify the appearance of the base (110).

The conducting layer (120) is laid on the base (110), and the way for the conducting layer (120) covered on the base (110) can be any conventional way in accordance with prior art such as screen printing, sputtering coating, evaporating coating and so on. The conducting layer (120) preferably is consisting of a carbon layer (122) and a silver layer (124). Preferably, the carbon layer (122) is laid on the silver layer (124) and the area of the carbon layer (122) is larger than the area of the silver layer (124). The conducting layer (120) comprises a first electrode pair (126) and a second electrode pair (128). Preferably, the first electrode pair (126) and the second electrode pair (128) both are respectively consisting of the carbon layer (122) and the silver layer (124). The first electrode pair (126) and the second electrode pair (128) both have a sample contact end and a sensing end respectively. A sample contact end is used for contacting with the sample, and the sensing end is used for near or contacting with a sensor device. More specifically, the first electrode pair (126) and the second electrode pair (128) are used for providing different sensing signal.

The isolating layer (130) is laid on the conducting layer (120). Preferably, the isolating layer (130) has a recess (132) used for exposing the sample contact end of the first electrode pair (126) and the second electrode pair (128). More specifically, the recess (132) of the isolating layer (130), the base (110) and the cover (150) are cooperating to form a sample chamber used for accommodating the sample. The following is a more specific illustration for the sample chamber, the first electrode pair (126) and the second electrode pair (128).

The sample chamber contains a first end (1321) and a second end (1322). The first end (1321) and the second end (1322) are disposed in relative position and the first end (1321) has a sample entrance. More specifically, the sample is filled from the first end (1321) of the sample chamber toward the second end (1322). In the sample chamber, the sample contact end of the first electrode pair (126) is far away from the first end (1321) and the sample contact end of the second electrode pair (128) is close to the first end (1321). More specifically, the sequence for the sample chamber filled with the sample from the sample entrance is first contacting with the second electrode pair (128) and then the first electrode pair (126). To be noticed, when the filled sample volume insufficient, the sample cannot fully cover a surface area of the first electrode pair (126) and the second electrode pair (128) respectively. Therefore, the test strip of the preferred embodiment in accordance with the present invention provides the first electrode pair and the second electrode pair respectively disposed in different site of the sample chamber. The layout of the electrode pair is used for detecting the signal from different site so as to determine the sample distribution state that replaced the conventional layout set an extra fill-detected electrode in the sample chamber.

The reagent layer (140) is covered in the recess (132) and used for reacting with the analyte in the sample. Preferably, the reagent layer (140) can comprise biological active materials (such as enzyme), enzyme co-factor, stabilizer (such as high molecular polymer), buffer and so on, but the present invention shall not be limited in this. For example, the analyte in the sample and the reagent layer are executed the redox reaction to induce electron transmission on the electrode so as to detect the electrical signal for analyte concentration Further, the detected electrical signal also can be used for determining the sample distribution state.

The cover (150) is laid on the reagent layer (140) and the cover (150) preferably comprises a notch (152) and/or a hole (154). The notch (152) set on the lateral side of the cover (150) and disposed align with the sample entrance. Preferably, the position of the notch (152) is relevant to the first end (1321) of the sample chamber in the isolating layer (130). The notch (152) is used for letting the sample more easily absorbed in the sample chamber. The hole (154) is opened on the cover (150) and near the second end (1322) of the sample chamber in the isolating layer (130). The hole (154) is used for air flowing. When the sample chamber is unfilled with the sample, the sample chamber is formed an air communication channel from the outside through the sample entrance to the hole (154). When the sample chamber is filled with the sample, the hole (154) provides an attraction force by the air communication so as to absorb the sample into the sample chamber.

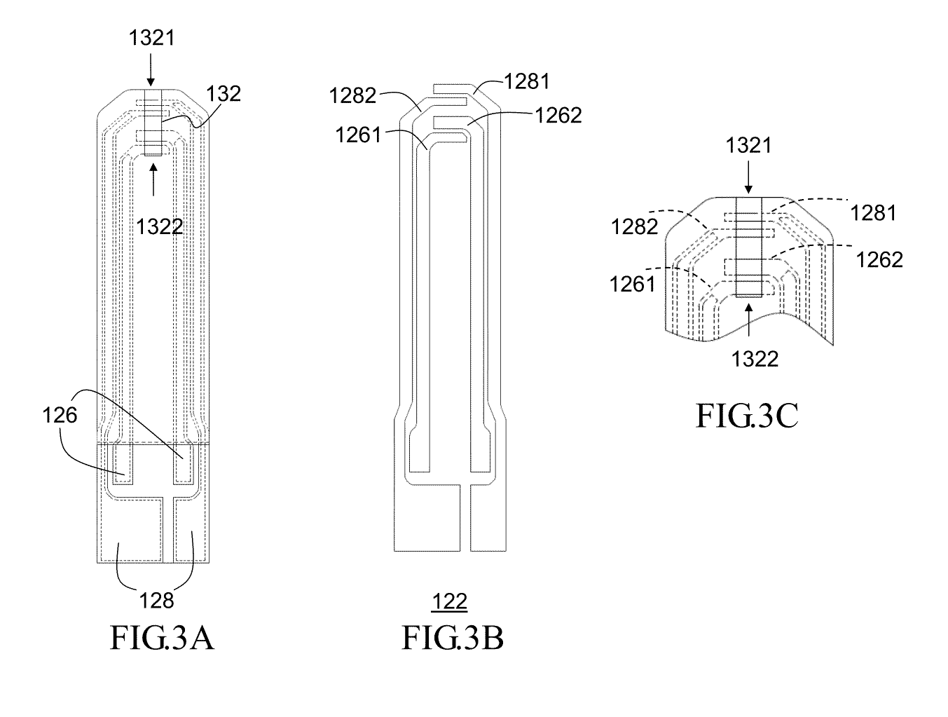

FIG. 3A is a schematic perspective view of a conducting layer and an isolating layer in FIG. 1 in accordance with the present invention. FIG. 3B is a schematic perspective view of a carbon layer in FIG. 3A. FIG. 3C is a partial enlarged schematic perspective view at one end of the strip in FIG. 3A. Please refer to FIGS. 3A to 3C in combination. In accordance with the present embodiment, the first electrode pair (126) and the second electrode pair (128) respectively comprises a working electrode and a counter electrode, which are a first working electrode (1261), a first counter/reference electrode (1262), a second working electrode (1281) and a second counter/reference electrode (1282). Preferably, the counter/reference electrode can have the function that the counter electrode and/or the reference electrode do. The electrode of the first electrode pair (126) and the second electrode pair (128) can be arranged side by side. Preferably, the electrode arrangement of the first electrode pair (126) and the second electrode pair (128) from the sample entrance to rear end of the sample chamber sequentially is the second working electrode (1281), the second counter/reference electrode (1282), the first counter/reference electrode (1262) and the first working electrode (1261). In other words, the second working electrode (1281) is close to the first end (1321) of the sample chamber and the first working electrode (1261) is close to the second end (1322) of the sample chamber, and the second counter/reference electrode (1282) and the first counter/reference electrode (1262) are disposed in the middle of the second working electrode (1281) and first working electrode (1261).

In the embodiment described above, the exhibited number of the working electrode and the counter/reference electrode is one choice of an embodiment of the present invention, and those skilled in the art can change the electrode number as needed. For example, the first electrode pair and the second electrode pair can share with a common counter/reference electrode. The following is a more specific illustration for the common electrode.

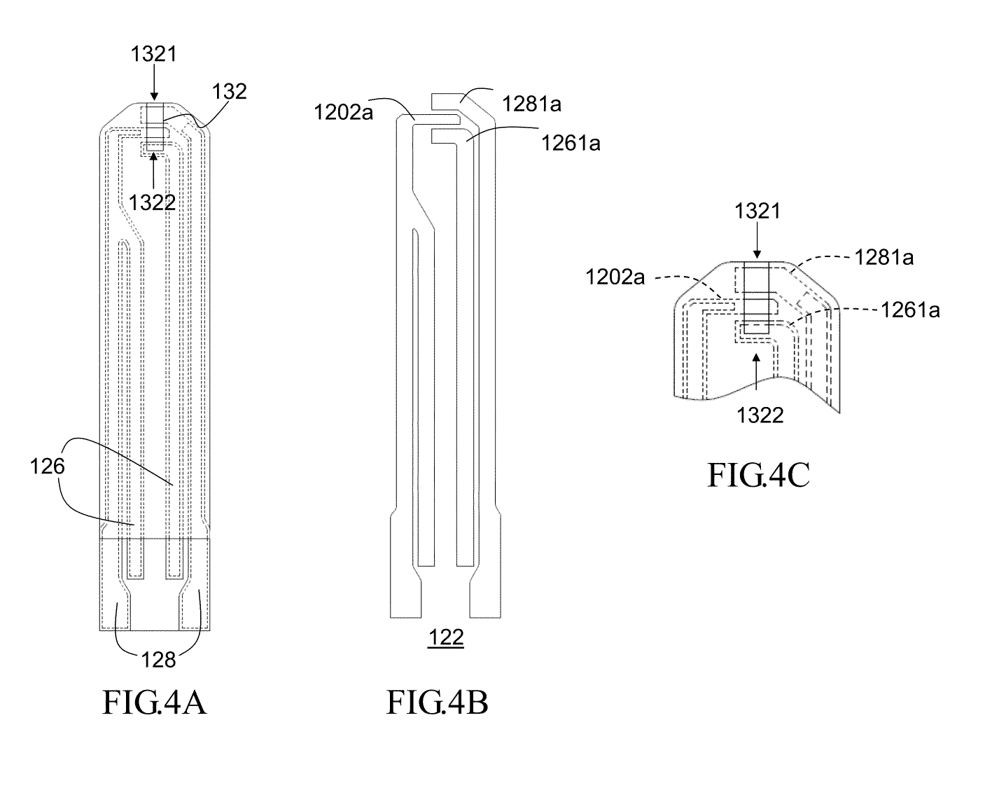

FIG. 4A is a schematic perspective view of a second preferred embodiment of the conducting layer and the isolating layer in accordance with the present invention. FIG. 4B is a schematic perspective view of a carbon layer in FIG. 4A. FIG. 4C is a partial enlarged schematic perspective view at one end of the strip in FIG. 4A. Please refer to FIGS. 4A to 4C in combination. In accordance with the present embodiment, the first electrode pair comprises a common counter/reference electrode (1202a) and a first working electrode (1261a), and the second electrode pair comprises the common counter/reference electrode (1202a) and a second working electrode (1281a). The electrode arrangement of the first electrode pair and the second electrode pair from the sample entrance to rear end of the sample chamber sequentially is the second working electrode (1281a), the common counter/reference electrode (1202a) and the first working electrode (1261a). In other words, the second working electrode (1281a) is close to the first end (1321) of the sample chamber and the first working electrode (1261a) is close to the second end (1322) of the sample chamber, and the common counter/reference electrode (1202a) is disposed in the middle of the second working electrode (1281a) and the first working electrode (1261a). To be noticed, the side by side arrangement of the electrode pattern of the first electrode pair and the second electrode pair will let the working electrode close to the counter/reference electrode. In other words, the electrode pattern of the working electrode closed to the counter/reference electrode in the same electrode pair means that no other electrode disposed in the middle of these two electrodes for the electrode pattern.

In the embodiment described above, the electrode arrangement of the first electrode pair and the second electrode pair to be arranged side by side is one choice of an embodiment of the present invention. Those skilled in the art can change the design of electrode arrangement as needed, such as the working electrode and the counter/reference electrode can be set on the same plan or parallel with opposite plan. For example, the electrode arrangement of the working electrode and the counter/reference electrode can be for face to face. The following is more specific illustration for the electrode arrangement on the test strip.

FIG. 5 is a schematic perspective view of a third preferred embodiment of the electrochemical biosensor strip in accordance with the present invention. Please refer to FIG. 5. In accordance with the present embodiment, the test strip (100b) comprises a base (110b), a conducting layer, an isolating layer (130b), a reagent layer and a cover (150b). Preferably, the conducting layer comprises a working electrode and a counter/reference electrode, and the working electrode and the counter/reference electrode are disposed parallel with opposite plan and communicated through the sample to form a conducting electrode pair. For example, the conducting layer comprises three electrode pairs which respectively is a common counter/reference electrode (1202b), a first working electrode (1261b), a second working electrode (1281b) and a third working electrode (1291b). The common counter/reference electrode (1202b) is printed on the base (110b), and the first working electrode (1261b), the second working electrode (1281b) and the third working electrode (1291b) are printed on the cover (150b), but the present invention shall not be limited in this. In other embodiment, those skilled in the art can change the printed number or the disposed position of the working electrode and the counter/reference electrode as needed. For example, the conducting layer can be one working electrode and two counter/reference electrodes which the working electrode printed on the base and the counter/reference electrode printed on the cover.

According to the aspect of the present invention as described above, in accordance with the present embodiment, the isolating layer (130b) is disposed between the base (110b) and the cover (150b) and replaced a recess for a channel. Preferably, the channel is cross a short side of the isolating layer and the channel, the base (110b) and the cover (150b) are cooperating to form a sample chamber used for accommodating the sample. The reagent layer (not shown) is disposed in the sample chamber, which is used for reacting with the analyte in the sample. The following is a more specific illustration for the arrangement of the working electrode and the counter/reference electrode in the sample chamber.

The sample chamber contains a first end (1321b) and a second end (1322b). The first end (1321b) and the second end (1322b) are disposed in relative position and the first end (1321b) has a sample entrance. The electrode arrangement of these electrode pairs from the sample entrance to rear end of the sample chamber sequentially is the second electrode pair, the third electrode pair and the first electrode pair. In other words, the second working electrode (1281b) is close to the first end (1321b) of the sample chamber and the first working electrode (1261b) is close to the second end (1322b) of the sample chamber, and the third working electrode (1291b) is disposed in the middle of the second working electrode (1281b) and the first working electrode (1261b), but the present invention shall not be limited in this. Those skilled in the art can change the number of the electrode pairs or the number of the electrode disposed in the middle of the first electrode pair and the second electrode pair.

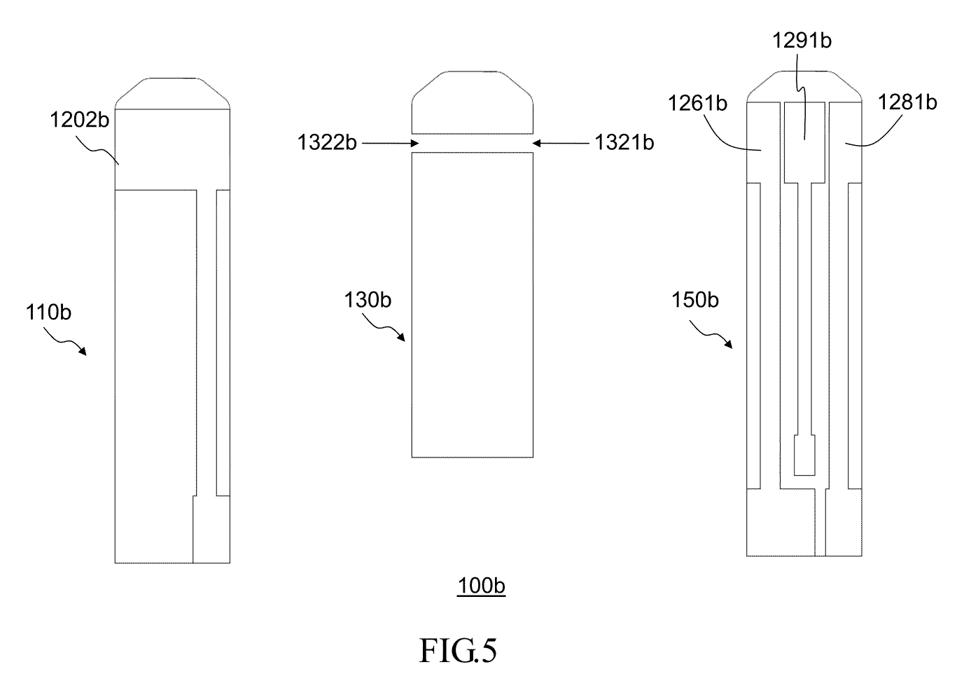

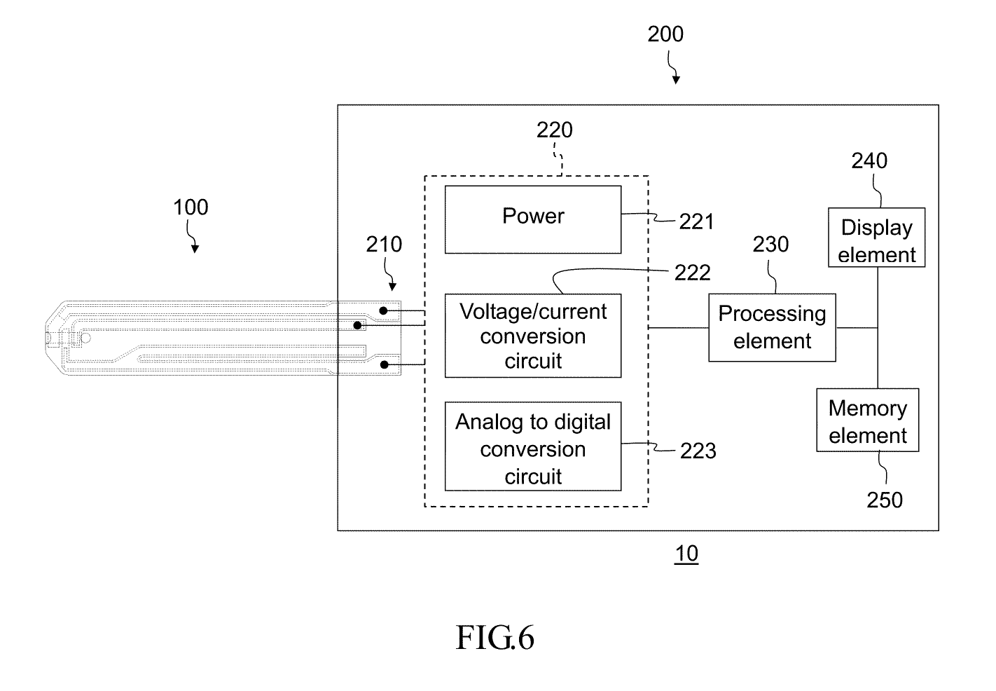

FIG. 6 is a block diagram of a preferred embodiment of a system for filling sample detection in accordance with the present invention. Please refer to FIG. 6. In accordance with the present embodiment, a system (10) is provided and used for determining an analyte concentration in a sample. The system (10) comprises a test strip (100) and a sensor device (200). Preferably, the sensor device (200) can be the electrochemical sensing device. More preferably, the sensor device (200) can be the electrochemical biosensing meter used for inserting an electrochemical biosensor strip. The sensor device (200) comprises a connector (210), a detecting element (220) and a processing element (230).

The connector (210) is used for inserting the electrochemical biosensor strip (100). More specifically, the connector (210) preferably comprises a plurality of terminal components which respectively connected with each electrode.

The detecting element (220) is used for detecting an electrical signal which obtained from the first electrode pair and the second electrode pair when the sample contacted therewith. Preferably, the detecting element (220) comprises a power (221), a voltage/current conversion circuit (222) and an analog to digital conversion circuit (223), and the detecting element (220) is communicated with the processing element (230). The detecting element (220) preferably is receiving a control signal from the processing element (230) to let the power (221) apply a voltage through the connector (210) to the electrochemical biosensor strip (100). The sample is reacting in the reagent layer of the electrochemical biosensor strip (100) to perform the electrochemical reaction and produce an electrical signal detecting by the voltage/current conversion circuit (222) so that the analog to digital conversion circuit (223) switches the electrical signal into a digital signal then transmit to the processing element (230).

The electrical signal comprises a first electrical signal, a second electrical signal and a third electrical signal. The detecting time of the third electrical signal is later than the detecting time of the first electrical signal and the second electrical signal. The first electrical signal is used for determining the filled state of the sample chamber when start to fill and the third electrical signal is used for determining the filled state of the sample chamber when filled. Preferably, the first electrical signal is obtained from the second electrode pair, the second electrical signal is obtained from the first electrode pair, and the third electrical signal is obtained from the first electrode pair, but the present invention shall not be limited in this. More specifically, the sensor device (200) detects the electrical signals which obtained from different distance away from the sample entrance so as to determine the distribution state of the sample in the sample chamber, and let the electrical signal which most close to the sample entrance to being the final detected signal so as to determine whether the sample chamber substantially filled.

The processing element (230) is used for calculating the first electrical signal, the second electrical signal and the third electrical signal to determine the distribution state of the sample in the sample chamber. Preferably, the first electrical signal, the second electrical signal or the third electrical signal is voltage value, current value, resistance value, impedance value, capacitance value or any combination from the one of description above, but the present invention shall not be limited in this. Moreover, determining the distribution state of the sample in the sample chamber is determining the flow velocity of the sample distributed in the sample chamber. The method for determining the distribution state of the sample will be described later.

In a preferred embodiment of the present invention, the sensor device (200) further comprises a display element (240). The display element (240) is connected with the processing element (230) and used for receiving the signal from the processing element (230) to display a processing procedure. Preferably, the processing procedure can be included but not limited in the step of determining the sample chamber sufficiently filled with the sample so as to continue the procedure for determining the analyte concentration in the sample, or the step of determining the sample chamber insufficiently filled with the sample so as to stop the procedure for determining the analyte concentration in the sample. More specifically, the display element (240) can utilize different interface such as sound, image, number character, alphabet symbol or light signal, but the present invention shall not be limited in this. For example, the display element (240) can be a liquid crystal screen used for showing the text message indicated sample chamber sufficiently filled so as to start the analyte measurement procedure. To be noticed, the display element (240) can be one or plurality interface coordinated to show the information described above. For example, the display element (240) can be a red light illuminant to lighted or twinkled when the sample chamber substantially unfilled and a liquid crystal screen to show the text message for reminding user to change the test strip which unfilled sample.

In a preferred embodiment of the present invention, the sensor device (200) further comprises a memory element (250). The memory element (250) is used for storing the information such as the analyte concentration detected from the sample, a correction parameter for different batch of the biosensor strip, a predetermined value for difference value between each electrical signals or a predetermined value which each electrical signals needed to satisfy. The memory element (250) can be any carrier for saving information or integrated with the processing element. For example, the memory element (250) can be removable secure digital memory card (SD card), electrically erasable programmable read only memory (EEPROM) and so on, but the present invention shall not be limited in this.

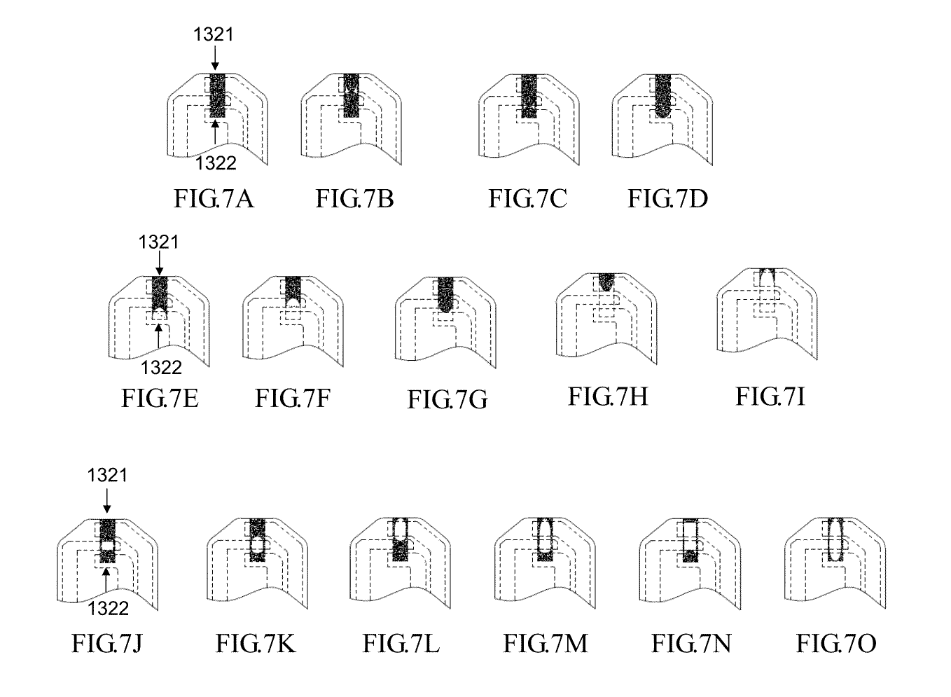

FIGS. 7A to 7O are perspective views of different distribution state of the sample in the sample chamber in FIG. 4C. Please refer to FIGS. 7A to 7O in combination. In accordance with the present embodiment, the electrode arrangement of the test strip in FIG. 4C is an illustration for instance, but the present invention shall not be limited in this. The sample is received from the sample entrance and flowing from the first end (1321) toward the second end (1322) of the sample chamber. When the sample volume is sufficient, the sample fully covered on the surface area of the first electrode pair (126) and the second electrode pair (128) as FIGS. 7A to 7D shown. When the sample volume is insufficient, the sample is not fully covered the electrodes flowing from the first end (1321) to the second end (1322) as FIGS. 7E to 7I shown. Conventional method for detecting insufficient sample volume is setting an extra fill-detected electrode on the second end (1322) or detecting an electrical signal detected from the site near the second end (1322). However, when the sample volume is insufficient, the liquid sample preliminary distributes along the edge of the sample chamber due to adhesion force and cohesion force caused by sample flowing in a narrow space to let the center portion of the sample chamber formed a void space as FIGS. 7J to 7O shown. Therefore, the sample distributed at the edge of second end (1322) in the sample chamber may unexpectedly to activate the conventional sample detection so that misjudge the sample chamber is sufficiently filled to make severely detection error. In addition, the sample chamber has a three dimension space for accommodating the sample so that the electrode arrangement of the electrode pair shall not be limited in two dimension space. Therefore, the following is a more different embodiment specific illustrated for arranging the first electrode pair and the second electrode pair in stereoscopic space of the sample chamber.

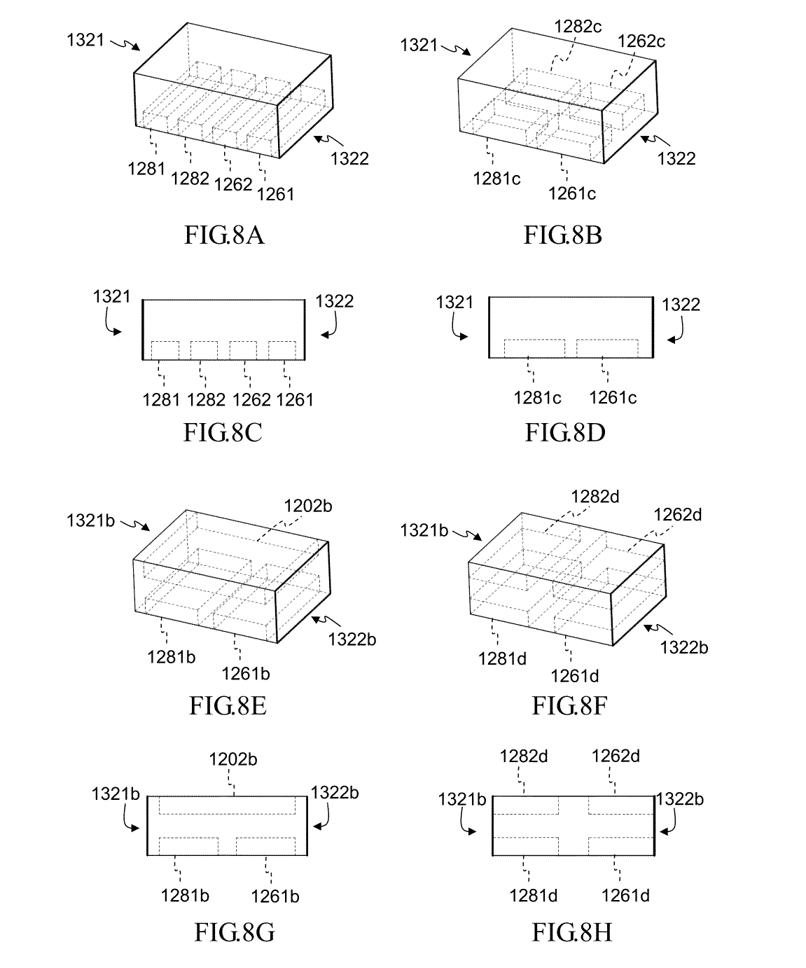

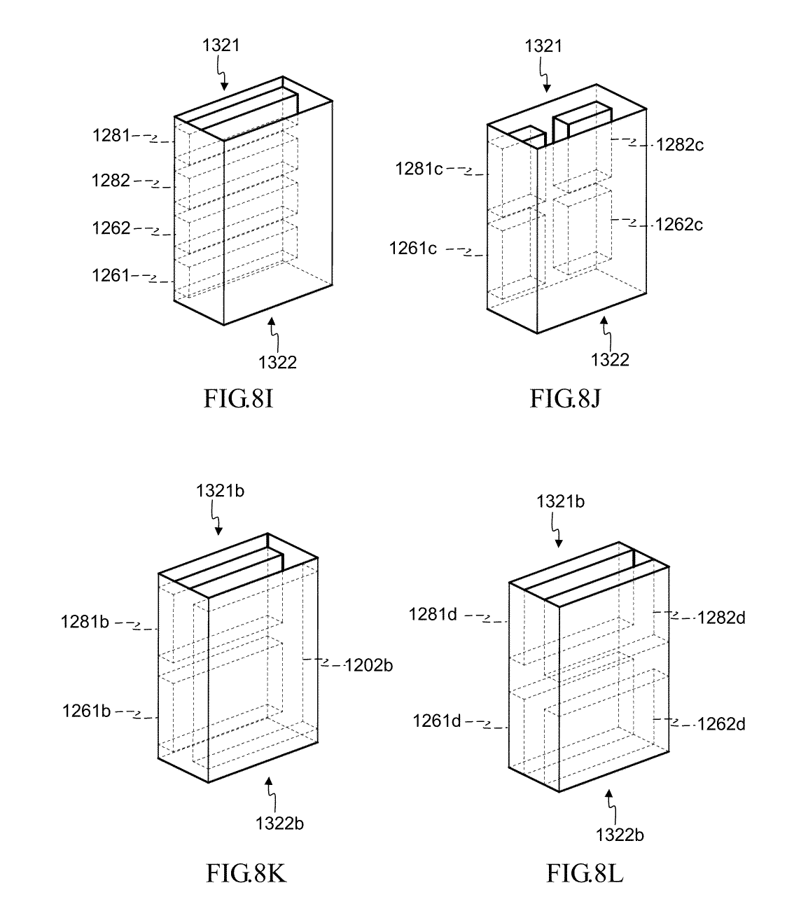

FIGS. 8A to 8L are schematic perspective views of different preferred embodiment of a first electrode pair and a second electrode pair disposed in the sample chamber in accordance with the present invention, wherein FIGS. 8C, 8D, 8G and 8H are respectively a lateral side view of FIGS. 8A, 8B, 8E and 8F. In these Figures, the sample chamber and the electrodes exposed from the sample entrance are drawn by solid line and other electrodes of the electrode pair in the sample chamber are drawn by dotted line. According to the side by side arrangement of the electrode pattern, please refer to FIGS. 3C, 8A and 8C in combination. In accordance with the present embodiment, the first electrode pair and the second electrode pair are disposed on the same plan by one direction arrangement in the sample chamber. In other words, each electrode is linear in the sample chamber from the first end (1321) to the second end (1322). For example, the electrode closest to the first end (1321) can be the second working electrode (1281) and the electrode closest to the second end (1322) can be the first working electrode (1261). In addition, please refer to FIGS. 8B and 8D in combination. In accordance with the fourth preferred embodiment, the first electrode pair and the second electrode pair are disposed on the same plan by two directions arrangement in the sample chamber. For example, the second working electrode (1281c) and the second counter/reference electrode (1282c) are disposed on the same plan and both closed to the first end (1321) in the sample chamber, and the first working electrode (1261c) and the first counter/reference electrode (1262c) are disposed on the same plan and both closed to the second end (1322) in the sample chamber.

According to the face to face arrangement of the electrode pattern, please refer to FIGS. 5, 8E and 8G in combination, wherein the FIGS. 8E and 8G are omitted the drawing of the third electrode pair. In accordance with the third preferred embodiment, the first electrode pair and the second electrode pair are disposed on different plans and shared with the common counter/reference electrode. In other words, the common counter/reference electrode (1202b) is disposed on a plan and adjacent to the first end (1321b) and the second end (1322b). The second working electrode (1281b) and the first working electrode (1261b) are disposed on an another plan opposite to the plan disposed the common counter-reference electrode (1202b) and respectively closed to the first end (1321b) and the second end (1322b) of the sample chamber. Please refer to FIGS. 8F and 8H in combination. In accordance with the fifth preferred embodiment, the first electrode pair and the second electrode pair are disposed on different plans and respectively have the working electrode and the counter/reference electrode in the sample chamber. For example, the second working electrode (1281b) and the second counter/reference electrode (1282b) are disposed on different plans and both closed to the first end (1321b) of the sample chamber and the first working electrode (1261b) and the first counter/reference electrode (1262b) are disposed on different plans and both closed to the second end (1322b) of the sample chamber.

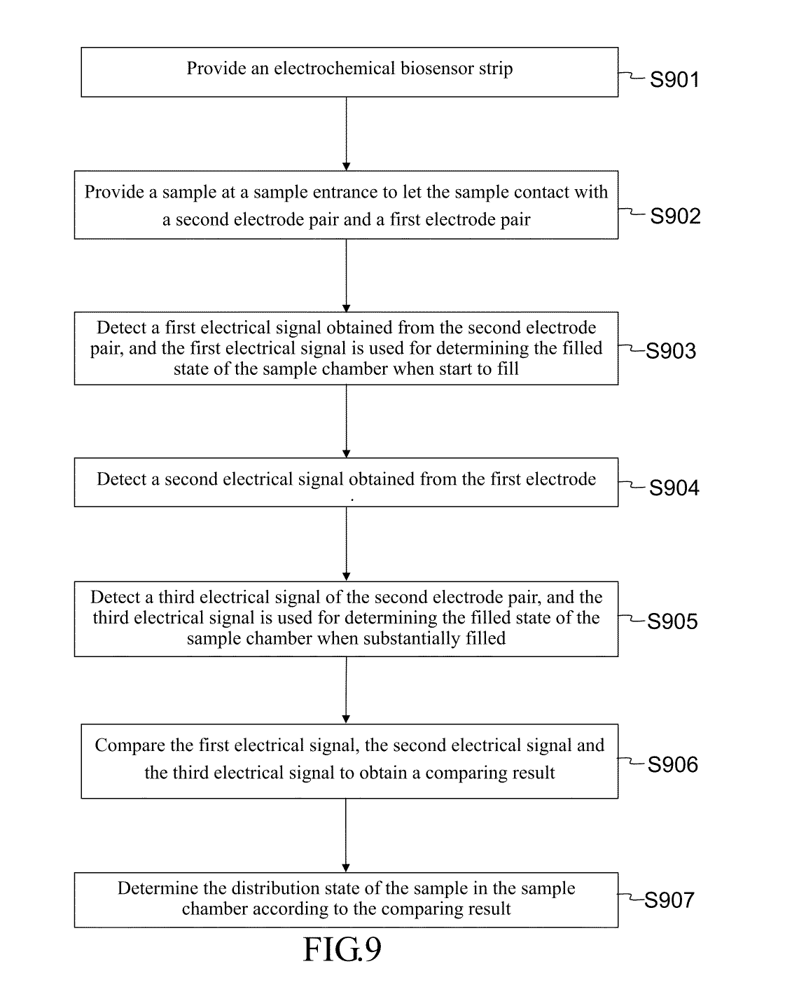

FIG. 9 is a flow chart of a preferred embodiment of a method for filling sample detection in accordance with the present invention. Please refer to FIGS. 4A to 4C and 9 in combination. The method of the embodiment in accordance with the present invention provides an electrochemical biosensor strip used for determining an analyte concentration in a sample in step S901. Preferably, the electrochemical biosensor strip comprises a sample chamber and a conducting layer. The sample chamber contains a first end and a second end. The first end and the second end are disposed in relative position and the first end has a sample entrance. The conducting layer comprises a first electrode pair and a second electrode pair and one end of the first electrode pair and the second electrode pair respectively disposed in the sample chamber, wherein the end of the first electrode pair is far away from the first end of the sample chamber and the end of the second electrode pair is close to the first end of the sample chamber.

In step S902, provide the sample at the sample entrance to let the sample contact with the second electrode pair and the first electrode pair. More specifically, the sample flowing sequence is first contacting the second electrode pair and then contacting the first electrode pair. The sample has different distribution state depending on the different sample filled volume. For example, when the sample volume is sufficient, the sample distribution state is distributed as FIGS. 7A to 7D shown, and when the sample volume is insufficient, the sample distribution state is distributed as FIGS. 7E to 7O shown, but the present invention shall not be limited in this.

In step S903, detect a first electrical signal obtained from the second electrode pair, and the first electrical signal is used for determining the filled state of the sample chamber when start to fill. In step S904, detect a second electrical signal obtained from the first electrode pair. Preferably, the second electrical signal is used for determining the filled state of the sample chamber presumption to fill. In step S905, detect a third electrical signal obtained from the second electrode pair, and the third electrical signal is used for determining the filled state of the sample chamber when sufficiently filled. Preferably, the first electrical signal, the second electrical signal or the third electrical signal can be voltage value, current value, resistance value, impedance value, capacitance value or any combination from the one of the description above. Preferably, the detecting time of the third electrical signal is later than the first electrical signal and the second electrical signal. More specifically, the first electrode pair and the second electrode pair disposed at different distance from the sample entrance are used for detecting the electrical signals to determine the sample chamber sufficiently filled state. In other words, the rule of determining the sample chamber sufficiently filled is repetitively detecting the electrical signal obtained from the electrode close to the sample entrance, or detected the electrical signal obtained from the electrode closed to the first end of the sample chamber to be the final detecting signal. To be noticed, conventional skill only detecting the first electrical signal and the second electrical signal, and let the second electrical signal or the electrical signal obtained from the electrode closed to the second end of the sample chamber to identify the sample chamber is sufficiently filled so that misjudge the unfilled sample distribution state such as FIGS. 7J to 7O for an incorrect determination.

In step S906, compare the first electrical signal, the second electrical signal and the third electrical signal to obtain a comparing result. In step S907, determine the distribution state of the sample in the sample chamber according to the comparing result. Preferably, the comparing result can be the first electrical signal, the second electrical signal and the third electrical signal all satisfy with a predetermined value so that indicate the sample chamber sufficiently filled with the sample. For example, following the electrical signal has an illustration of the current value for instance, and the first electrical signal, the second electrical signal and the third electrical signal are described as Table 1.

TABLE 1
Test result of current value of the electrical signals for different sample
distribution state.

| | | First | Second | |
|---|---|---|---|---|
| Current | Predetermined | Electrical | Electrical | Third Electrical |
| Value (uA) | Value | Signal | Signal | Signal |
| Test 1 | 3.00 | 3.00 | 3.20 | 3.40 |
| Test 2 | 3.00 | 3.10 | 1.50 | 3.20 |
| Test 3 | 3.00 | 3.15 | 3.33 | 0.85 |

In test 1, all electrical signals are satisfied with the predetermined value 3.00 so that indicate the sample chamber insufficiently filled with the sample as FIGS. 7A to 7D shown. In test 2, the second electrical signal is not satisfied with the predetermined value 3.00 so that indicate the sample chamber insufficiently filled with the sample. More specifically, the second end of the sample chamber is insufficiently filled with the sample as FIGS. 7E to 7G shown. In test 3, the third electrical signal is not satisfied with the predetermined value 3.00 so that indicate the sample chamber insufficiently filled with the sample. More specifically, the first end of the sample chamber is insufficiently filled with the sample as FIG. 7L shown, but present invention shall not be limited in this. Preferably, the detected value of the electrical signal can be singular test value or accumulated test value.

Moreover, the comparing result preferably can be a difference value compared between the first electrical signal, the second electrical signal and the third electrical signal, and the difference value less than a predetermined value to indicate the sample chamber sufficiently filled with the sample. Preferably, the predetermined value can be a singular number value or a range of values. For example, the electrical signal has illustration of the current value for instance, and the calculated current ratio from the first electrical signal, the second electrical signal and the third electrical signal are described as Table 2.

TABLE 2
Test result of current ratio of the electrical signals for different sample
distribution state.

| | | 1st electrical | | |
|---|---|---|---|---|
| | | signal/2nd | 2nd electrical | 3rd electrical |
| Current | Predetermined | electrical | signal/3rd | signal/1st |
| ratio | Value | signal | electrical signal | electrical signal |
| Test 1 | 0.5~1.5 | 0.938 | 0.941 | 1.133 |
| Test 2 | 0.5~1.5 | 2.067 | 0.469 | 1.032 |
| Test 3 | 0.5~1.5 | 0.946 | 3.918 | 0.270 |

In test 1, the current ratios obtained from the electrical signals are all conform with the range of the predetermined value 0.5 to 1.5 so that indicate the sample chamber sufficiently filled with the sample as FIGS. 7A to 7D shown. In test 2, the current ratio obtained from the first electrical signal versus the second electrical signal and that obtained from the second electrical signal versus the third electrical signal exceed the range of the predetermined value 0.5 to 1.5 so that indicate the sample chamber insufficiently filled with the sample. More specifically, the second end of the sample chamber is insufficiently filled with the sample as FIGS. 7E to 7G shown. In test 3, the current ratio obtained from the second electrical signal versus the third electrical signal and that obtained from the third electrical signal versus the first electrical signal exceed the range of the predetermined value 0.5 to 1.5 to indicate the sample chamber insufficiently filled with the sample. More specifically, the first end of the sample chamber is insufficiently filled with the sample as FIG. 7L shown, but the present invention shall not be limited in this.

In addition, the comparing result preferably can be used for determining the flow velocity of the sample in the sample chamber. More specifically, the electrical signal such as the first electrical signal, the second electrical signal and the third electrical signal are detected the sample distribution at a finite time period. The comparing result of the electrical signals unsatisfied with the predetermined value or the difference value between the electrical signals less than the predetermined value may be caused by the insufficient sample volume to cover the electrode area incompletely. The sample distributed abnormality in the sample chamber may be caused by the aberration of test strip or the sample itself, and therefore, it does not recommended the user to refill the sample into the test strip when the finite time period has passed. The finite time period is set with 2 seconds for instance, the processing element has received the first electrical signal and the third electrical signal but has not received the second electrical signal within 2 seconds to indicate the flow velocity of the sample distributed abnormality in the sample chamber such as FIG. 7H or 7I shown. Preferably, the display element of the sensor device can display the message for the abnormal distribution state of the sample chamber and stop the procedure for determining the analyte concentration of the sample so as to recommend user to change the test strip.

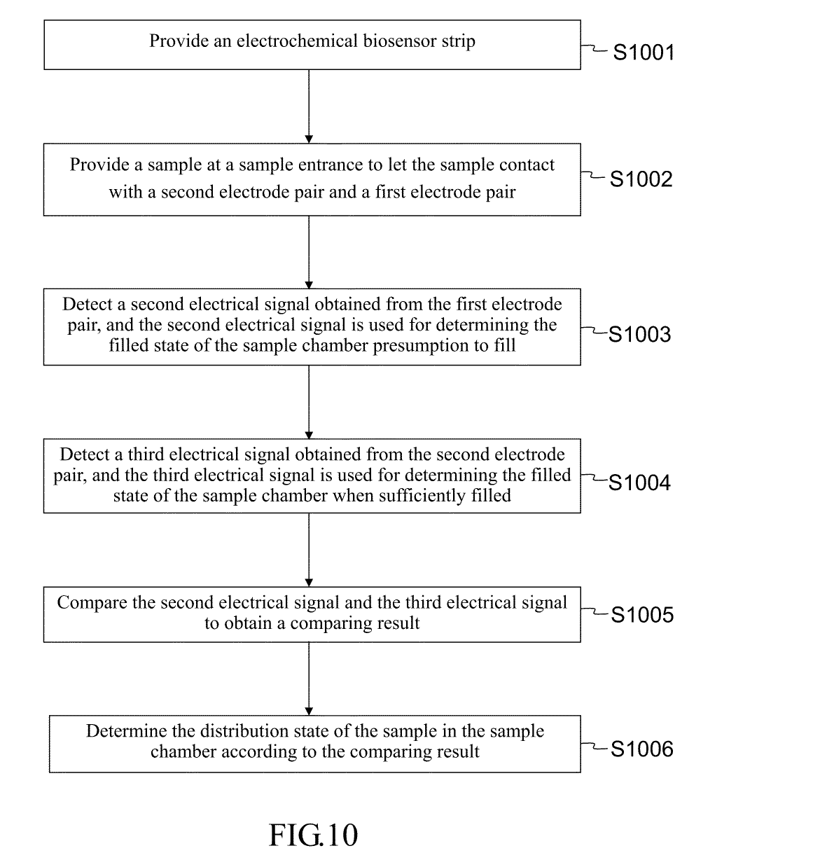

FIG. 10 is a flow chart of another preferred embodiment of a method for filling sample detection in accordance with the present invention. Please refer to FIGS. 4A to 4C and 10 in combination. In accordance with the present embodiment, provide an electrochemical biosensor strip used for determining an analyte concentration in a sample in step S1001. Preferably, the configuration of the electrochemical biosensor strip is similar with the strip as FIGS. 8A to 8L shown, and please refers the strip described above.

In step S1002, provide the sample at a sample entrance to let the sample contact with a second electrode pair and a first electrode pair. In step 1003, detect a second electrical signal obtained from the first electrode pair, and the second electrical signal is used for determining the filled state of the sample chamber presumption to fill. In step S1004, detect a third electrical signal obtained from the second electrode pair, and the third electrical signal is used for determining the filled state of the sample chamber when sufficiently filled. More specifically, in the present embodiment, the detected sequence of the electrical signal is first detected the electrical signal obtained from the second end of the sample chamber and then detected the electrical signal obtained from the first end of the sample chamber.

In step S1005, compare the second electrical signal and the third electrical signal to obtain a comparing result. In step S1006, determine the distribution state of the sample in the sample chamber according to the comparing result. The method provided from the embodiment in accordance with the present invention is identified the both situation for the sample chamber unfilled with the sample at the first end or the second end such as FIGS. 7E to 7O shown.

Although possible types of the electrochemical biosensing meter, system and measuring method for analyte measurement incorporating filled sample detection in accordance with the present invention has been described in the embodiment above, those skilled in the art shall recognized that the electrochemical biosensing system and measuring method can be designed differently. Therefore, the spirit of the present invention shall not be limited to these possible types described above of electrochemical biosensing system and measuring method in accordance with the present invention. In other words, repetitively detecting the electrical signals or the detected electrical signal sequence first obtained from the site far away from the sample entrance and then obtained from the site closed to the sample entrance so as to determine the sample distribution state which is the key spirit and scope of the present invention. The followings are some other embodiments in accordance with the present invention for those skilled in the art to know more about the spirit of the present invention.

According to the embodiment of the present invention in FIGS. 1 to 4C, the recess (132) of the isolating layer (130), the base (110) and the cover (150) are cooperating to form the sample chamber used for accommodating the sample which is one choice of an embodiment of the present invention. Those skilled in the art can change the structure of the sample chamber as needed. In accordance with the other embodiment, the channel structure can replace the recess structure.

Following the description above, the sample chamber can be formed with different structure such as recess or channel so that the sample chamber can be the one termination opened, the two terminations opened or the multiple terminations opened. Furthermore, those skilled in the art can change the position of the recess, channel or the sample entrance on the test strip as needed. For example, the test strip can be top filled type or side filled type due to the sample entrance set on the short edge or the long edge of the test strip for different handedness user.

According to the embodiment of the present invention in FIGS. 8A to 8H, the sample is flowing into the sample chamber by lateral direction. In other words, the sample chamber set parallel with the horizontal line is one choice of an embodiment of the present invention. In accordance with the other embodiment, please refer to FIGS. 8I to 8L in combination, the sample can fill into the sample chamber by vertical direction which the sample chamber is perpendicular with the horizontal line. Furthermore, the shape of the sample chamber and the appearance of each electrode have illustration for regular type, but the present invention shall not be limited in this. For example, the sample chamber can be cylindrical type and the appearance of electrode can be L type, trapezoidal type, rhombus type, symmetrical conformation or other irregular type. In addition, the permutation for each electrode arranged in the sample chamber is one choice of an embodiment of the present invention. Those skilled in the art can change the number and the disposition of the electrode pair arranged in the sample chamber as needed.

According to the embodiment of the present invention in FIGS. 1 and 2, the hole (154) opened on the cover (150) and near the second end (1322) of the sample chamber formed with the isolating layer (130) which is one choice of an embodiment of the present invention. Those skilled in the art can change the position of the hole opened on the electrochemical biosensor strip as needed. For example, the hole can open on the base or the lateral side of any isolating layer.

According to the embodiment of the present invention in FIGS. 1 to 5, the isolating layer (130) having the recess (132) used for exposing one end of the first electrode pair (126) and the second electrode pair (128) which is one choice of an embodiment of the present invention. Those skilled in the art can change the number and the configuration of the isolating layer set in the test strip as needed.

According to the embodiment of the present invention in FIGS. 3A to 3C, there are two working electrodes and two counter/reference electrodes. According to the embodiment of the present invention in FIGS. 4A to 4C, there are two working electrodes and one counter/reference electrode. According to the embodiment of the present invention in FIG. 5, there are three working electrodes and one counter/reference electrode. The above description is one choice of an embodiment of the present invention. Those skilled in the art can change the number and the disposition of the working electrode and the counter/reference electrode set on the test strip as needed. In accordance with the other embodiment, the test strip can dispose one or a plurality of electrode pairs.

According to the embodiment of the present invention in FIGS. 9 and 10, obtained the difference value from comparing the electrical signals and the difference value less than the predetermined value is used to indicate the sample chamber sufficiently filled with the sample, and the value has illustrated by calculated current ratio which is one choice of an embodiment of the present invention. Those skilled in the art can change the calculating method for the difference value obtained from the electrical signals as needed. In accordance with the other embodiment, the calculating method can include but not limit with adding, subtraction, multiplication, division or any mathematical algorithm such as a difference value obtained from two values subtraction or a ratio obtained from test values division.

According to the embodiment of the present invention in FIG. 9, comparing the first electrical signal, second electrical signal and the third electrical signal and determining the distribution state of the sample in the sample chamber which is one choice of an embodiment of the present invention. Those skilled in the art can change the repetitively detected number of electrical signals obtained from the first electrode pair and the second electrode pair as needed. In accordance with the other embodiment, the method further comprises detecting a fourth electrical signal obtained from the first electrode pair. Furthermore, in accordance with the another embodiment, those skilled in the art can change the number of electrode pair set in the sample chamber and the corresponding electrical signal obtained from the electrode pair, or increasing the detected number for electrical signal as needed.

According to the embodiment of the present invention in FIG. 9, detect the third electrical signal obtained from the second electrode pair, and the third electrical signal is used for determining the filled state of the sample chamber when sufficiently filled in step S905. In other words, the third electrical signal detected from the second electrode pair close to the sample entrance which is one choice of an embodiment of the present invention. Those skilled in the art can change the selected electrode corresponding to detect the third electrical signal. In accordance with the other embodiment, please refer FIG. 8A for instance, the third electrical signal can be detected from the second working electrode (1281) and the first counter/reference electrode (1262) or detected from the second counter/reference electrode (1282) and the first working electrode (1261).

Accordingly, the electrochemical biosensing meter, the system and the measuring method for analyte measurement incorporating filled sample detection regardless of the sample flowing path when filled in the sample chamber and repetitively detected the electrical signal obtained from different site in the sample chamber, especially the electrical signal close to the sample entrance so as to determine the sufficiently filled state of the sample chamber and increase the credibility of the analyte measuring. Furthermore, there are also other advantages in some embodiments of the present invention exemplarily listed as follows:

1. The method for analyte measurement incorporating filled sample detection in accordance with the present invention repetitively detected the electrical signals obtained from different electrode pair in the sample chamber is increasing the accuracy for determining the distribution of the sample filled in the sample chamber.

2. The method for analyte measurement incorporating filled sample detection in accordance with the present invention detected the electrical signal close to the sample entrance to be final detected signal used for determining distribution state of sample in the sample chamber so that resolve the misjudged problem of sample distribution for making measurement error of the analyte concentration caused by sample volume insufficient to let the center portion of the sample chamber formed a void space due to the sample adhesion force.

3. The electrochemical biosensing system for analyte measurement incorporating filled sample detection in accordance with the present invention does not need to dispose an extra fill-detected electrode on the test strip so as to decrease the manufacture cost of the test strip.

4. The electrochemical biosensing system for analyte measurement incorporating filled sample detection in accordance with the present invention wherein the electrode pair disposed the working electrode and the counter/reference electrode adjacent with each other on the test strip so that shorten the distance of the electrode interval so as to decrease the voltage value applied from the sensor device and elevate the sensitivity of electrical signal detection.

More exemplary embodiments and advantages of the present invention may be ascertained by reviewing the present disclosure and the accompanying drawing. It is intended that the description and embodiments with reference to the accompanying drawing to be considered as exemplary only.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A method for filling sample detection, comprising:
providing an electrochemical biosensor strip used for determining an analyte concentration in a sample, which comprising
a sample chamber containing a first end and a second end, and the first end and the second end disposed in relative position, and the first end having a sample entrance; and
a conducting layer comprising a first electrode pair and a second electrode pair and one end of the first electrode pair and the second electrode pair respectively disposed in the sample chamber, wherein the end of the first electrode pair is far away from the first end of the sample chamber and the end of the second electrode pair is close to the first end of the sample chamber;
providing the sample at the sample entrance to let the sample fill into the sample chamber;
detecting a second electrical signal obtained from the first electrode pair;
detecting a third electrical signal obtained from the second electrode pair, and the third electrical signal used for determining the filled state of the sample chamber;
comparing the second electrical signal and the third electrical signal; and
determining the distribution state of the sample in the sample chamber.

2. The method as claimed in claim 1, before the step of detecting the second electrical signal further comprising:
detecting a first electrical signal obtained from the second electrode pair, and the first electrical signal used for determining the filled state of the sample chamber when start; and
comparing the first electrical signal, the second electrical signal and the third electrical signal to determine the distribution state of the sample in the sample chamber.

3. The method as claimed in claim 1, wherein comparing the electrical signals to determine the distribution state of the sample in the sample chamber which is obtained a difference value from comparing the electrical signals and the difference value less than a predetermined value to indicate the sample chamber insufficiently filled with the sample.

4. The method as claimed in claim 1, wherein comparing the electrical signals to determine the distribution state of the sample in the sample chamber which is the electrical signals all satisfied with a predetermined value to indicate the sample chamber insufficiently filled with the sample.

5. The method as claimed in claim 1, wherein determining the distribution state of the sample in the sample chamber which is determining the flow velocity of the sample distributed in the sample chamber according to a comparing result from the comparing step.

6. The method as claimed in claim 1, wherein the electrical signals are voltage value, current value, resistance value, impedance value, capacitance value or any combination from the one of description above.

7. An electrochemical biosensing meter for filling sample detection, which used for inserting an electrochemical biosensor strip to determine an analyte concentration in a sample, and the electrochemical biosensor strip comprising a sample chamber including a sample entrance, and a conducting layer including a first electrode pair and a second electrode pair and one end of the first electrode pair and the second electrode pair respectively disposed in the sample chamber, wherein the end of the first electrode pair is far away from the sample entrance and the end of the second electrode pair is close to the sample entrance, and the meter comprising:
a connector used for inserting the electrochemical biosensor strip;
a detecting element used for detecting electrical signals respectively obtained from the first electrode pair and the second electrode pair when the sample contacted, the electrical signals including a first electrical signal and a third electrical signal obtained from the second electrode pair and a second electrical signal obtained from the first electrode pair, a detecting time of the third electrical signal being later than the detecting time of the first electrical signal and the second electrical signal, and the first electrical signal used for determining the filled state of the sample chamber when start and the third electrical signal used for determining the filled state of the sample chamber when sufficiently filled; and
a processing element used for calculating the first electrical signal, the second electrical signal and the third electrical signal to determine the distribution state of the sample in the sample chamber.

8. The meter as claimed in claim 7, wherein the processing element is used for calculating a difference value which obtained from the disparity between the first electrical signal, the second electrical signal and the third electrical signal and the difference value less than a predetermined value to indicate the sample chamber sufficiently filled with the sample.

9. The meter as claimed in claim 7, wherein the processing element is used for calculating the first electrical signal, the second electrical signal and the third electrical signal to compare with a predetermined value and all electrical signals satisfy with the predetermined value to indicate the sample chamber sufficiently filled with the sample.

10. The meter as claimed in claim 7, wherein the processing element is used for determining a flow velocity of the sample distributed in the sample chamber based on the distribution state of the sample.

11. The meter as claimed in claim 7, wherein the first electrical signal, the second electrical signal or the third electrical signal is voltage value, current value, resistance value, impedance value, capacitance value or any combination from the one of description above.

12. The meter as claimed in claim 11, further comprising a display element connected with the processing element and used for receiving the signal from the processing element to display a processing procedure.

13. The meter as claimed in claim 12, wherein the processing procedure displayed on the display element comprises a step of the sample chamber sufficiently filled with the sample so as to continue the procedure for determining the analyte concentration in the sample, or a step of the sample chamber insufficiently filled with the sample so as to stop the procedure for determining the analyte concentration in the sample.

14. The meter as claimed in claim 11, further comprising a memory element used for storing the analyte concentration detected from the sample, correction parameters for different batch of the biosensor strip, the predetermined value for comparing with the difference value obtained from the electrical signals or the predetermined value for each electrical signals satisfied with.

15. A system for filling sample detection, which is used for determining an analyte concentration in a sample, comprising:
an electrochemical biosensor strip comprising
a base;
a conducting layer disposed on the base and comprising a first electrode pair and a second electrode pair;
a reagent layer contacted with the conducting layer used for reacting with the analyte in the sample; and
a cover cooperating with the base to form a sample chamber; and
an electrochemical biosensing meter as claimed in claim 7, used for optionally inserting the electrochemical biosensor strip.

16. The system as claimed in claim 15, wherein one end respectively of the first electrode pair and the second electrode pair on the electrochemical biosensor strip are used for contacted with the sample and the other end respectively of the first electrode pair and the second electrode pair are used for close to or contacted with the electrochemical biosensing meter.

17. The system as claimed in claim 15, wherein the first electrode pair and the second electrode pair respectively comprises a working electrode and a counter/reference electrode and the electrical signals are voltage value, current value, resistance value, impedance value, capacitance value or any combination from the one of description above.

18. The system as claimed in claim 17, wherein the working electrode and the counter/reference electrode are disposed in the same plane or parallel with opposite plan.

19. The system as claimed in claim 18, wherein the working electrode of the first electrode pair is closed to the second end of the sample chamber, the working electrode of the second electrode pair is closed to the first end of the sample chamber, and the counter/reference electrodes of the first electrode pair and the second electrode pair are disposed in the middle of each working electrodes.

20. The system as claimed in claim 19, wherein the counter/reference electrodes of the first electrode pair and the second electrode pair are shared with a common electrode.
